(19) United States
(12) Patent Application Publication
(10) Pub. No.: US 2006/0186261 A1
(43) Pub. Date: Aug. 24, 2006

(54) Vertical take-off and landing aircraft

(76) Inventor: Stefan Unzicker, Sulzberg (DE)

Correspondence Address: Stefan Unzicker, Sparenberg 1, Sulzberg, 87477, DE

(21) Appl. No.: 10/531,149

(22) PCT Filed: Oct. 11, 2002
(86) PCT No.: PCT/EP02/11386

§ 371 Date: Apr. 12, 2005

(51) Int. Cl. B64C 29/00

(52) U.S. Cl. 244/12.1

(57) ABSTRACT

The present invention discloses an aircraft capable of vertical take-off and landing. The aircraft comprises a single constant speed variable pitch propeller (3), a fuselage (2), an empennage (21, 22) and main wings (6) fixed to the fuselage (2); arranged similar to a conventional aircraft, but sized and positioned for vertical flight. A stator is positioned a minimal distance behind the propeller so as to compensate the torque caused by the propeller. The aircraft comprises high lift and high drag devices such as flaps (19) and a leading edge slat (7) on the main wings (6), and a fuselage spoiler (18). The positioning of the center of gravity (23) allows for a stable nose-up take-off and landing, NUTOL, position. The propeller generated airflow (PGA) over the main wings (6) and high lift and drag devices (7, 18, 19) creates lift and drag forces. Due to the NUTOL position, the sum of the propeller thrust, the lift forces and the drag forces on the aircraft results in a vertical force and no forward (horizontal) force, thus enabling vertical flight. Roll, pitch and yaw control is achieved by aerodynamic surfaces positioned inside and outside of the PGA.

### 1.0 TECHNICAL FIELD

The invention relates to an aircraft which can act as a Vertical Take-Off and Landing (VTOL) aircraft, and a method for using such an aircraft.

### 2.0 STATE OF THE ART

Aircrafts having vertical or steep take off and landing capabilities are well known to the man skilled in the art:

Helicopters, and gyrocopters which use an additional forward thrust propeller are well known vertical take-off aircrafts. However, helicopters and gyrocopters are very expensive and have a very limited speed (normally maximum about 300 km/h) and limited range compared to non-helicopter aircrafts.

Table 1 discloses the results of a search of the prior art in this technical field that are relate to the present invention. The similarities and differences are identified. The improving qualities of the present invention are also noted. Brief descriptions of the related prior art follow.

DE-A42 37 873 published on 19 May 1994 discloses a VTOL aircraft which generates an airflow over all wings and control surfaces by means of jet engines and a gas redirection system. This aircraft further uses flaps in order to increase the surface of the wings during start and landing.

DE-A-44 05 975 published on 31 Aug. 1995 discloses a VTOL aircraft having a completely vertical take-off position, with the use of a single propeller acting as a lifting rotor. The cockpit pivots within the fuselage. The aircraft further uses auxiliary engines or propellers in the wings to enable maneuvering and stabilize the aircraft during hover flight.

U.S. Pat. No. 4,928,907 published on 29 May 1990 discloses a compound helicopter capable of conventional winged horizontal airplane flight. The helicopter incorporates a separate propeller for transitional and horizontal flight. A primary object of this patent was to find an alternate means for torque compensation as opposed to the tall rotor conventionally used in helicopters.

U.S. Pat. No. 5,407,150 published on 18 Apr. 1995 discloses a VTOL aircraft having a thrust unit for vertical flight, and low speed forward flight. The airflow from this thrust unit is directed downwards by a duct system, thereby creating lift. An additional thrust unit is required for full forward flight.

U.S. Pat. No. 5,056,737 published on 15 Oct. 1991 discloses a VTOL aircraft having a touch-down area in the tail for vertical landing. Upon landing, the aircraft tumbles due to gravity into a stable horizontal position.

U.S. Pat. No. 3,966,142 published on 29 Jun. 1976 discloses a VTOL aircraft, having a fuselage that is composed of two main sections which are hinged. Both the propulsion unit and the empennage are rotated about the main fuselage.

U.S. Pat. No. 5,687,934 published on 18 Nov. 1997 discloses a vertical takeoff aircraft, having a duct system providing suction as well as blowing of air to provide a lifting force in the hover phase. During the hover phase, the single propeller provides low pitch propeller airflow for yaw control, pitch control and roll control.

U.S. Pat. No. 5,395,073 published on 7 Mar. 1995 discloses VTOL aircraft with an outer free or rotating wing. The inner wing is fixed to the fuselage. The fuselage is able to rotated with respect to the tail boom assembly, thereby attaining a tilted, nose-up configuration. For vertical take-off and landing, the fuselage and thrust source are pivoted to a generally vertical orientation.

U.S. Pat. No. 3,995,794 published on 7 Dec. 1976 discloses a VTOL aircraft comprising a biplane arrangement. The upper wing is rotatable, permitting steeper take-off and landing angles. The propulsion means is also carried by the upper wing, and thus rotates with it.

Further, an aircraft (Bell/Boing: “V22”) has been proposed, in which the propeller- and motor units on the wings are tilted during transition from hover flight to cruise flight and vice versa. The tilting of the propeller- and motor units has to be performed in a very co-ordinated manner by the pilot, who normally will have to be assisted by an electronic control system.

Further, an aircraft (British Aerospace: “Sea Harrier”) has been proposed, which utilizes jet engines that can be rotated 90 degrees to provide the vertical thrust needed for takeoff and landing. This requires additional jets, and a very skillful pilot. Also, the heat and pressure created by the jet engines in the vertical position make it practical for use only on aircraft carriers having heavy metal decks, since they would damage the concrete runways used in commercial aviation.

DE-A-24 33 951 published on 5 Feb. 1976 discloses and aircraft for vertical take off and landing. The aircraft 1n this application is similar to a conventional aircraft for horizontal take-off and landing, and has two propellers positioned on each of the main wings in order to create a propeller airflow over the entire lifting surfaces of the wings. This aircraft is brought into a nose-up pitched position before starting and landing, in which position the propeller airflow over the main wing will create a lifting force in an oblique rearward direction. With the pitch angle and the thrust adjusted appropriately, the thrust and lift will combine to create a resultant vertical force. If the resultant force is of greater magnitude than the force of gravity acting on the aircraft, it may lift the aircraft. During hover flight of the aircraft, stability is achieved through controls for pitch control, roll control and yaw control which are positioned completely within the propeller airflow.

WO-A-0162591 published on 30 Aug. 2001 discloses a VTOL aircraft comprising a propeller, a lower front wing and an upper rear wing. The angles of attack of the wings can be individually adjusted with respect to the produced air-stream, to achieve the desired resultant upward force. This angle of attack adjustment also allows for roll control.

U.S. Pat. No. 5,098,034 published on 24 Mar. 1992 discloses a VTOL aircraft having a fixed canard wing and a rotating primary wing. Two propellers are fitted to the fixed canard wing, creating an influx over the canard wing, and an efflux over the rotating primary wing. The aircraft also consists of standard tail group. The aircraft is also capable of conventional horizontal take-off and landing.

Despite the fact that the vertical take-off and landing capability of an aircraft is highly desirable, they have almost no share in the aircraft market.

Due to the multitude of disadvantageous design aspects of the above mentioned prior art, they are overly complex, expensive, difficult to maneuver and/or failure prone.

The present invention has a vast number of improving qualities over the prior art, these are described in Table 1 and section 4.0.

### 3.0 SUMMARY OF THE INVENTION

In order to avoid the complexity, costs and inefficiencies of the above mentioned concepts, an aircraft with the features defined in the independent apparatus claim is proposed, and further, a method for starting and landing such an aircraft is proposed.

Further advantageous features are defined in the dependent claims.

A key advantage with an aircraft according to the invention is that it can be designed very much like a conventional single engine non-vertical take-off and landing aircraft. The aircraft according to the invention requires only marginally more costs to produce than a similar conventional aircraft and can be operated like a conventional aircraft while it can also be used for most helicopter missions.

Compared to a conventional single engine aircraft, an aircraft according to the invention has a large wing 6 and flap 19 configuration which is subjected to a propeller generated airflow, PGA 4, to create lift. The control surfaces are positioned within the PGA 4 to ensure control of the three degrees of rotational freedom, (roll, yaw and pitch), during vertical flight. An aircraft according to the invention is also geared for a nose-up pitch position and further comprises high drag devices 7, 18, 19 in the PGA 4 to aid in vertical take-off as opposed to the conventional forward, horizontal take-off.

### 4.0 IMPROVEMENTS ON PRIOR ART

Table 1 identifies the main improvements of the present invention over the state of the art previously discussed. The improvements, denoted by a letter code, are identified and described below. The features identified are then further described in the general description section (6.0) with reference to the figures.

The present invention as disclosed is most similar to patents DE-A-24-33-951 and WO-A-01-62591-A1.

As previously described, patent application DE-A-24-33-951 proposes a VTOL aircraft in which at least 2 engines generate an airflow over the fixed main wing. The key improvements over this patent are the use of a single constant speed propeller (points A and B), and torque compensation by means of a stator (point C). In addition to these, the present invention also differentiates from this previous patent in the use of high drag devices to facilitate vertical flight (point J) and the unique wing-tip configuration (point K).

Relative patent application WO-A-01-62591-A1 is considered to be the closest prior art. The patent application discloses a VTOL aircraft propelled by a single propeller generating an airflow over the wings. The key improvements over this invention are the use of a fixed, non-hinged, main wing (point E), a stator for torque compensation (point C), an over-center process for achieving stable NUTOL position to enable vertical flight (described in section 6.10), high drag devices (point J), and the unique wing-tip configuration (point K). Further, the present invention does not make use of a secondary wing, or canard wing, which can be very detrimental (point F).

A—Single Propeller

A single propeller 3 for propelling the aircraft during vertical, horizontal and transitional flight, as in the present invention, improves the efficiency of the aircraft. Multiple engines are critical to engine failure, they must be extremely oversized so that in the occasion that one engine should fail, the other can complete the work of both. Multiple thrust units require very good coordination and thus enhanced effort by the pilot. Also, through the use of multiple engines, manufacturing and maintenance of the aircraft is expensive.

B—Inertial Propeller Torque Avoidance

During power changes, the propeller rpm changes. Power changes are necessary to achieve vertical flight. The change in rpm causes an inertial moment on the aircraft, which is critical during vertical flight as it will roll the aircraft. To avoid this phenomenon, the present invention makes use of a constant speed propeller 3. Such a propeller is well known, but its use to avoid an inertial moment during vertical flight is unheard of.

C—Stator for Aerodynamic Propeller Torque Compensation

The present invention incorporates a single thrust source 3, therefore a torque compensation means, such as a stator 29, needs to be incorporated into the aircraft in order to counter the rolling moment created by the thrust source on the aircraft. The propeller torque is more critical in VTOL aircraft than in conventional aircraft since there is no ambient airflow and the power required for vertical flight is generally much higher than for conventional aircraft.

The stator is an optimal torque compensation means because it is positioned in close proximity to the propeller. At a minimal distance, the stator is more effective since there is more angular component of the downstream airflow near the propeller, this means that the stator blades can have relatively small surface area. The close proximity also ensures that the torque is not carried along the aircraft, which will result in a lighter structure. The stator consists of at least 3 blades, which can be positioned so as not to interfere with the airflow over the main wing, as would a canard wing. Preferably, the stator comprises multiple blades in the order of 12, which would then be positioned all around the perimeter of the fuselage thus creating a uniform effect on the airflow. Further, the stator is advantageous because it reduces the angular component of the airflow, creating a more effective axial airflow over the main wing.

D—Fixed Thrust Source

In the present invention, the propeller 3 is fixed to the fuselage 2. Any system which involves rotating the engines and/or the propulsion units are prone to high gyroscopic and inertial effects, and thus require much more complicated maneuvering and stabilizing systems, which often involve assistance by electronic control. This assistance is undesired as it requires extensive tests and certification procedures. Also, such systems require heavier mechanisms to support the rotation or pivoting of the components, thus leading to greater inefficiencies.

E—Full Load on Main Wing

The full load is taken on the main wing 6 in the present invention. Multiple wings cause problems due to an adverse lift created by the forward (or canard) wing on the rear wing. Multiple wings also lead to more complex control systems.

F—Fixed Wing

In the present invention, the main wing 6 is fixed to the fuselage 2. Systems involving the pivoting or rotation of the wings or fuselage are very complex and require good coordination and enhanced effort by the pilot. The mechanisms required for pivoting large components of the aircraft are heavy and thus inefficient. Greater disturbances are experienced during transitional flight between vertical flight and horizontal flight with the use of hinged or rotating wings.

G—Attitude Control by Aerodynamic Surfaces

Attitude control during hover flight is achieved in the present invention by use of aerodynamic surfaces 8, 15, 16 which are affected by the PGA 4. The invention, therefore, does not require auxiliary engines or propellers, which would only increase the weight, cost, and complexity and reduce the ease of control.

H—No Redirected Exhaust or Airflow Through Ducts or Canals

The redirection of exhaust or airflow, present in many prior art, increases the complexity of the aircraft. Thus, the weight and the cost of manufacturing, maintenance and use all increase. Also, the control of such ducts requires very good coordination and enhanced effort by the pilot. The present invention uses a PGA 4, created over the main wing to generate lift, thus no such canals are necessary.

I—Stable Nose-Up Take-Off and Landing (NUTOL) Position

The vertical take off and landing of an aircraft according to the present invention is done by use of a stable NUTOL (nose-up take-off and landing) position in which the entire aircraft is tilted at a pitch angle θ; stable due to the positioning of the center of gravity 23. The NUTOL position is required to help create vertical flight, but is not excessive and thus not uncomfortable for crew or passengers.

J—High Drag Devices

The use of high drag devices 7, 18, 19 improves the vertical take off capability as it acts against the forward thrust force. With high drag devices, the aircraft can take off with less NUTOL pitch angle θ than a similar VTOL aircraft without such devices.

K—Wing-Tip Configuration

The present invention discloses a wing-tip arrangement 17, 27, 28 such that there is an aerodynamic surface that is not exposed to the affects from the generated airflow. This enables damping and stability during steady horizontal flight. A multitude of advantages also result due to the combination of winglet 28, tip tank 17 and endplate 27, including increasing the efficiency of the PGA, enhancing the moment of inertia in the roll axis, minimizing the unwanted fuel surge in the y-direction, optimizing a stabilizing fuel surge in the x-direction, alleviating the wing bending moment, decreasing internal loads, complying with aviation certification rules regarding the placement of the fuel tanks, reinstating coordinated flight, and acting as a housing for the main undercarriage 11.

TABLE 1
Related Patents

| Patent | A | B | C | D | E | F | G | H | I | J | K |
|---|---|---|---|---|---|---|---|---|---|---|---|
| DE 24 33 951 A | X | X | X | | | | | | | X | X |
| DE 42 37 873 A1 | X | X | X | | | | | X | X | | X |
| DE 44 05 975 A | | X | X | X | X | X | X | | X | X | X |
| U.S. Pat. No. | | X | X | | | | X | | X | | X |
| 1890059 A | | | | | | | | | | | |
| U.S. Pat. No. | | X | X | | | | X | X | X | | X |
| 2974899 A | | | | | | | | | | | |
| U.S. Pat. No. | | X | X | X | | X | | | X | | X |
| 3966142 A | | | | | | | | | | | |
| U.S. Pat. No. | | X | X | X | X | X | X | | X | | X |
| 3995794 A | | | | | | | | | | | |
| U.S. Pat. No. | X | X | X | X | X | X | | | X | X | X |
| 4928907 A | | | | | | | | | | | |
| U.S. Pat. No. | | X | X | | | | | | X | | X |
| 5056737 A | | | | | | | | | | | |
| U.S. Pat. No. | X | X | X | | X | X | | | X | X | X |
| 5098034 A | | | | | | | | | | | |
| U.S. Pat. No. | | X | X | X | X | X | | | X | X | X |
| 5395073 A | | | | | | | | | | | |
| U.S. Pat. No. | X | X | X | | | | X | X | X | X | X |
| 5407150 A | | | | | | | | | | | |
| WO 01/62591 A1 | | X | X | | X | X | | | X | X | X |
| CH 0100109 | | | | | | | | | | | |
| Bell/Boeing “V22” | X | X | X | X | | | | | X | X | X |
| British Aerospace | | X | X | | | | X | X | X | X | X |

‘X’ indicates that the present invention has made an improvement on the specified patent in the area corresponding to the letter code.
LETTER CODE of improving features of the present invention over existing patents:
A Single propeller
B Inertial torque avoidance
C Stator for torque compensation
D Fixed thrust source
E Full load on main wing
F Fixed wing
G Attitude control by aerodynamic surfaces
H No redirected exhaust or airflow through ducts or canals
I Stable nose-up take-off and landing (NUTOL) position
J High drag devices
K Wing-tip configuration

### 5.0 BRIEF DESCRIPTION OF THE DRAWINGS FIG. 1 shows an aircraft according to the invention with the key features identified, in a side view

FIG. 2 shows an aircraft according to the invention in a top view

FIG. 3 shows an aircraft according to the invention in a front view

FIG. 4 shows the creation of the PGA (Propeller Generated AirFlow) over the main wing

FIG. 5 shows a cross section of the main wing of the aircraft according to the invention

FIG. 6 shows a vector diagram explaining the summation of the forces acting on the aircraft without drag (a) and with drag (b)

FIG. 7 shows the hoisted tail, and the carry through area for the flaps

FIG. 8 shows an aircraft in a stable CHTOL (conventional horizontal take-off and landing) position

FIG. 9 shows an aircraft in two stable NUTOL (nose-up take-off and landing) positions

FIG. 10 shows a diagram explaining the need of a counter torque.

FIG. 11 demonstrates the effect of the stator in developing counter torque by illustrating a cross-section view (a) and a front view of the stator (b)

FIG. 12 shows the ventilate spoiler

FIG. 13 shows a ducted propeller with an outlet nozzle shaped to deflect the PGA

FIG. 14 shows the ineffective PGA regions

FIG. 15 shows an aircraft according to the present invention, with the propeller mounted in an alternative way.

FIG. 16 demonstrates the different lift created due to the left and right wings having different angles of incidence

FIG. 17 shows an aircraft according to the invention, in a ultra-light configuration with alternative landing gear.

FIG. 18 shows the nose of the aircraft, depicting the non-ducted propeller and stator, and the propeller and stator blade cross-sections at the respective radial position.

FIG. 19 shows the nose of the aircraft, depicting the ducted propeller and stator and the propeller and stator blade cross-sections at the respective radial position.

### 6.0 GENERAL DESCRIPTION

FIGS. 1, 2 and 3, show the side, top and front views, respectively, of a preferred embodiment of an aircraft 1 according to the invention. The key features are identified on these figures.

An aircraft according to the invention is similar to a single engine conventional aircraft, comprising a fuselage 2, a main wing 6 fixed to the fuselage 2, and a single constant speed propeller 3. The aircraft 1 is capable of vertical take-off and landing, as well as high speed horizontal flight.

### 6.1 Propeller Generated Airflow (PGA) and Resulting Lift

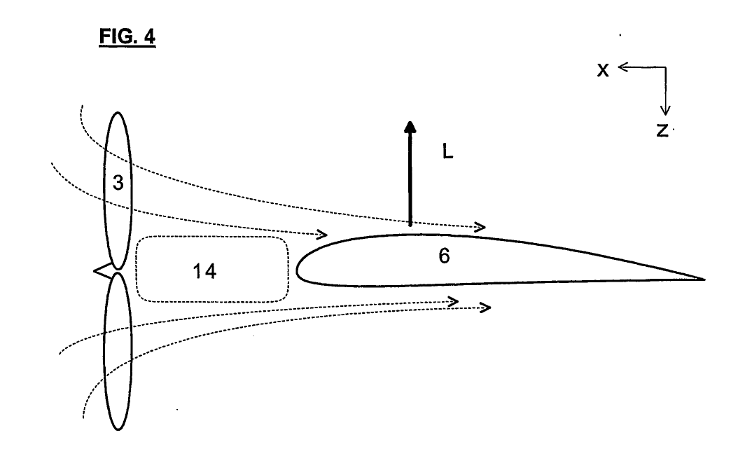

Flight (including take off and landing) of an aircraft 1 according to the invention is achieved by a PGA (propeller generated airflow) 4 over the main wing 6 created by a propeller positioned in front of the main wing 6. FIG. 4 demonstrates how the PGA 4 over the main wing 6 generates lift.

Propeller

According to the invention, the propeller consists of a constant speed propeller.

In a preferred embodiment, the propeller 3 of an aircraft 1 according to the invention is mounted in the nose of the fuselage 2.

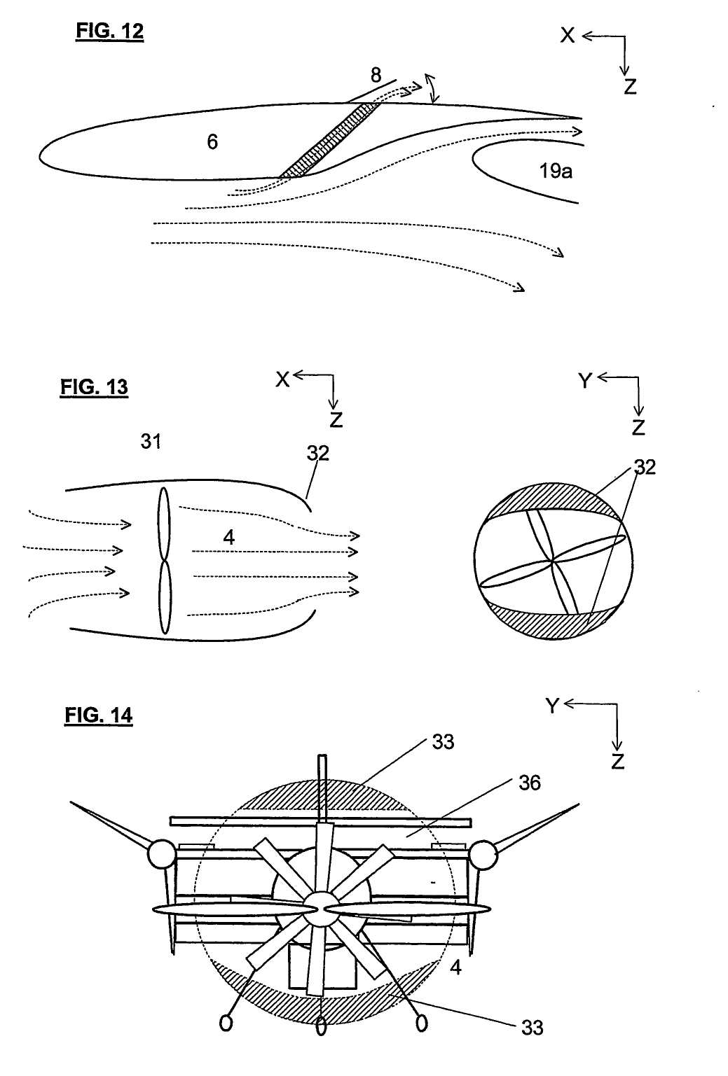

Further, the propeller 3 could comprise a duct 31, shown in FIG. 13, shaped to deflect the otherwise useless direction of airflow 33 in an effective direction of airflow 36, the effective direction 36 being in the path of the aerodynamic surfaces, illustrated in FIG. 14. A ducted propeller would, however, be heavier and cause more drag at high speeds.

Another, rather important, redirection of the propeller airflow is described in section 6.5 Torque Compensation, Stator.

Alternatively, the duct 31 could rotate with the propeller blades, thereby having the blades acting as spokes and the duct a rotating rim. This arrangement reduces the losses at the blade tips of a propeller 3, and provides a larger, more effective thrust. Again, however, the rotating rim would be heavier, and it could also impose problems concerning centrifugal forces acting on the rim.

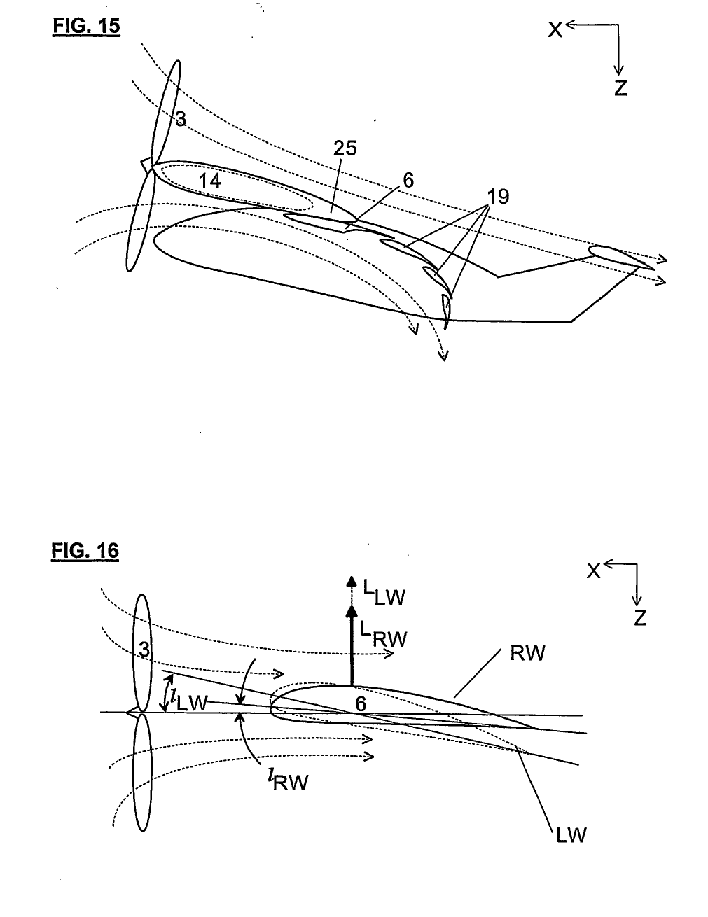

In an alternative embodiment, the propeller could be mounted above the fuselage 2, but still forward of the main wing. FIG. 15 shows an aircraft according to the invention, with the propeller 3 being mounted to a protrusion 25 extending forward from the central upper part of the fuselage 2.

Wing Unit

Vertical flight requires enhanced lift. To enhance the lift, the main wing 6 is equipped with leading edge and trailing edge high lift devices, also subjected to the PGA 4.

Trailing Edge

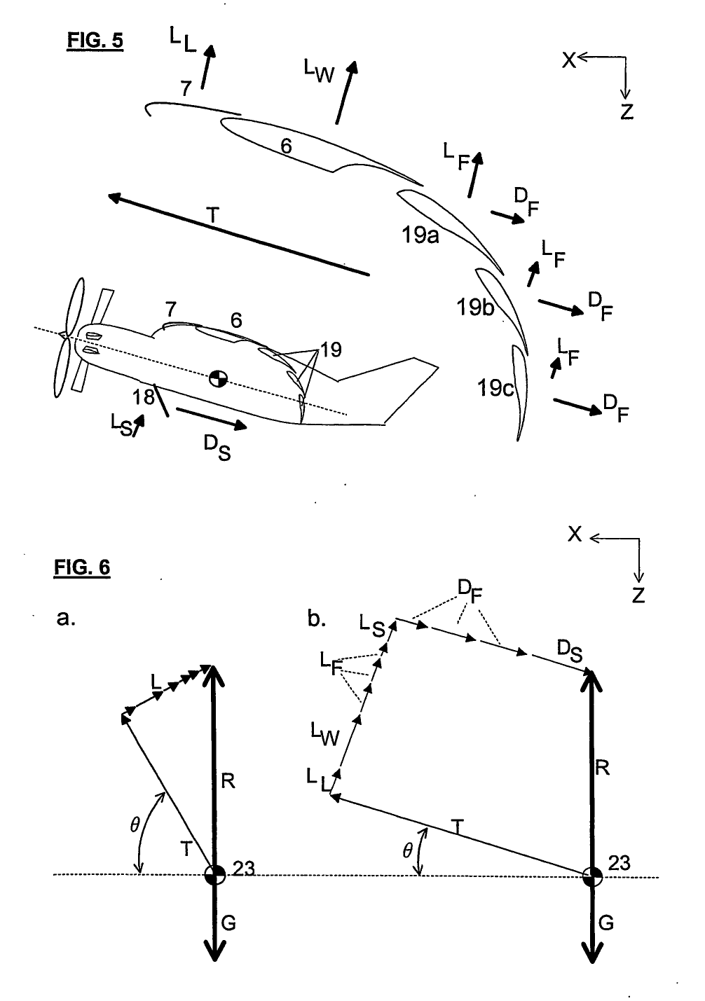

In a preferred embodiment, the main wing 6 has multi-Fowler type of flaps 19a, 19b, 19c arranged In the PGA 4, shown in FIG. 5.

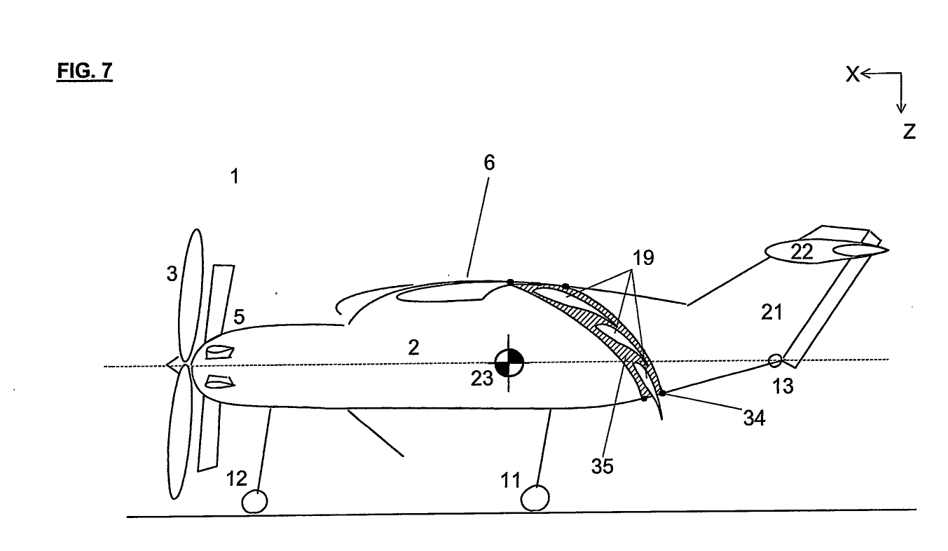

FIG. 7 shows the fuselage 2 in a preferred arrangement so that it extends only to the aft of the main wing 6, at which point the tail is attached by hoists. With this arrangement, the Fowler flaps 19 can be made with a carry through box for the main spars of each flap. The flaps are therefore full wingspan flaps, thereby enhancing the structural integrity and ease of controls.

In an alternate embodiment, the main wing 6 could be equipped with Handley page type of flaps.

Leading Edge

In a preferred embodiment, the main wing 6 is equipped with leading edge devices such as slats 7 to enhance the lift and to compensate the wing torsion moment about the y-axis.

In an alternate embodiment, the main wing 6 could be equipped with nose flaps, or Krueger flaps at the leading edge.

6.2 Reducing Forward Motion

Conventional Horizontal Take-off and Landing Position (CHTOL)

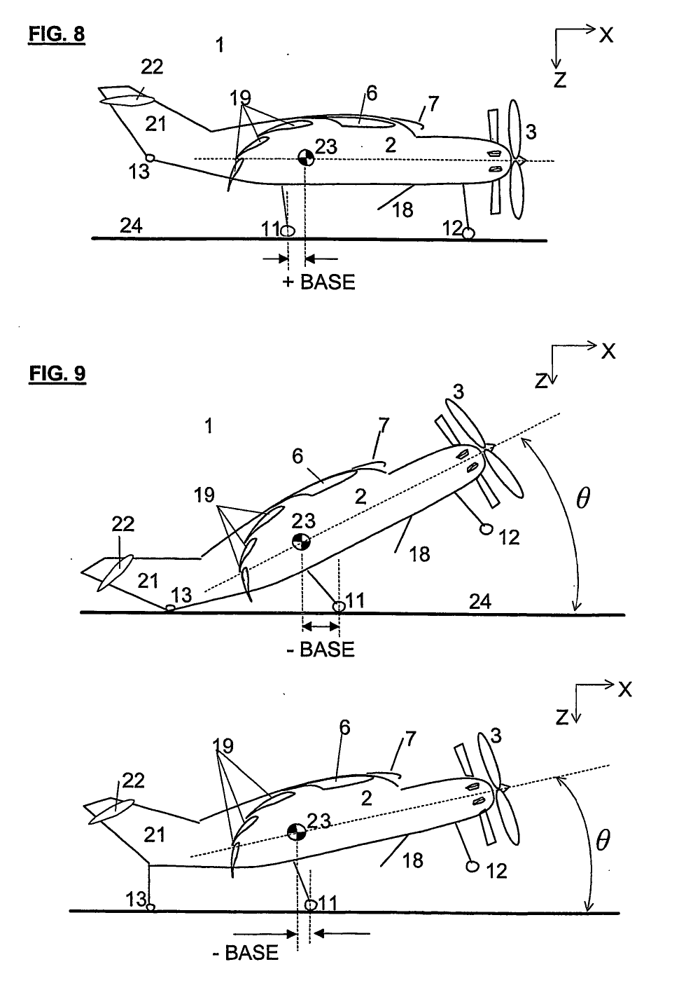

FIG. 8 shows an aircraft 1 according to the invention, standing in a stable CHTOL (conventional horizontal take-off and landing) position on main gear 11 and on a nose gear wheel 12. In this position, when the PGA 4 is applied an aircraft according to the invention will take-off in a conventional horizontal manner (i.e. with forward motion). An aircraft 1 according to the invention is also capable of a conventional horizontal landing.

In order to achieve solely vertical flight, the forward motion due to the thrust, T, from the propeller must be reduced to zero.

6.2.1 Nose-Up Take-off and Landing (NUTOL) Position

To reduce the forward motion, an aircraft 1 according to the invention can tilt into a stable NUTOL (nose-up take-off and landing) position. In FIG. 9 two NUTOL pitch angles θ are illustrated. At a certain NUTOL pitch angle θ, the horizontal component of the applied thrust T is completely balanced by the horizontal component of the lift L, illustrated in FIG. 6a, thus enabling solely vertical flight.

The NUTOL position is used for the vertical take-off and landing of an aircraft 1 according to the invention. FIG. 9 shows an aircraft 1 according to the invention standing in a stable. NUTOL position on the main gear wheel 11 and on a tail support 13, the tail support 13 being aft of the main gear wheel 11.

A key feature of the invention is that the whole aircraft 1 is tilted, and not just a single component such as the wings or engine.

6.2.2 High Lift and Drag Devices

To further decrease the forward motion without requiring large angles of NUTOL pitch angle 0, an aircraft 1 according to the invention comprises high drag devices.

In a preferred embodiment, the trailing edge flaps 19 arranged in the PGA 4 are deflected downward and extended backwards to an extreme during vertical flight such that they generate high drag. In a preferred embodiment, the leading edge devices 7 for high lift extend forward, but not as far downward as conventionally used. The downward extension is used on conventional aircraft to reduce drag during take-off, but the aircraft 1 according to the invention does not require drag minimization during take-off.

In a preferred embodiment, an aircraft 1 according to the invention is further equipped with a retractable fuselage spoiler 18 which generates high drag as well as contributing to the lift.

### 6.3 Vector Diagram Explanation of Vertical Flight:

To achieve vertical flight, the summation of the forces produced on the aircraft 1 must result in a resultant force R which is vertical (no horizontal component) acting on the center of gravity 23 of the aircraft 1.

FIG. 5 shows an aircraft 1 according to the invention during vertical flight, in a NUTOL position. The propeller airflow 4 over the main wing 6, Fowler flaps 19, leading edge slat 7, and fuselage spoiler 18 create lifting forces L_{W}, L_{F}, L_{L} and L_{S} on each component respectively in an oblique rearward direction. The components in the airflow also cause drag, the significant drag being caused by the Fowler flaps 19, D_{F} and the fuselage spoiler 18, D_{S}.

FIG. 6b represents the summation of the forces acting on the aircraft 1 in vertical flight. The forward horizontal component of the Thrust T is balanced by the backward horizontal components of the lift L and drag D forces. This results in no horizontal forces on the aircraft 1, therefore no horizontal movement. The vertical component of the thrust T and the lift forces L combine to created an upward force on the aircraft 1 that is only slightly diminished by the vertical component of the drag forces D. Altogether, the forces acting on the aircraft 1 will produce the required vertical resultant force R. If the resultant force R acting on the center of gravity 23 is greater than the force of gravity G, the aircraft 1 will lift vertically. If the resultant force R is less than the force of gravity G, the aircraft 1 will descend vertically.

It is clear from FIG. 6b that the NUTOL position of the aircraft 1, demonstrated by the angle θ from the horizontal plane, enables vertical flight by producing a lift component that counters the forward thrust applied. It is also clear from FIGS. 6a and 6b that the increased drag is of advantage for the vertical take-off of the aircraft 1, since this allows the NUTOL pitch angle θ to be reduced. FIG. 6a represents the vector summation of an aircraft without the high drag. The angle θ from the horizontal plane needed in order to obtain no resultant horizontal forces without the high drag is very large therefore it would be uncomfortable for passengers and pilots, and potentially less stable.

### 6.4 Vertical Climb and Descent

As described by the vector diagram, vertical climb of an aircraft 1 according to the invention is achieved by generating a resultant vertical force R that is greater than the force of gravity G. In order to increase this resultant force R, and thus climb vertically; the thrust T of the propeller 3 must be increased. The thrust T is used to create the lift L and drag D forces, therefore these forces are also increased when the thrust is increased. The magnitude of the vertical resultant force R is therefore increased without a significant divergence from the vertical path (i.e. the horizontal forces still balance so there will be minimal movement horizontally). Similarly, vertical descent of an aircraft 1 according to the invention occurs when the resultant vertical force R is less than the force of gravity G and is accomplish by decreasing the thrust T.

### 6.5 Torque Compensation

Inertial propeller torque is caused by acceleration of the rpm necessary for power change.

Preferably, the propeller 3 is a constant speed propeller which is state of the art in many propeller aircraft, and eliminates the resultant inertia and acceleration related torque on the aircraft 1 that would otherwise be caused by changes in power by changing the propeller rpm.

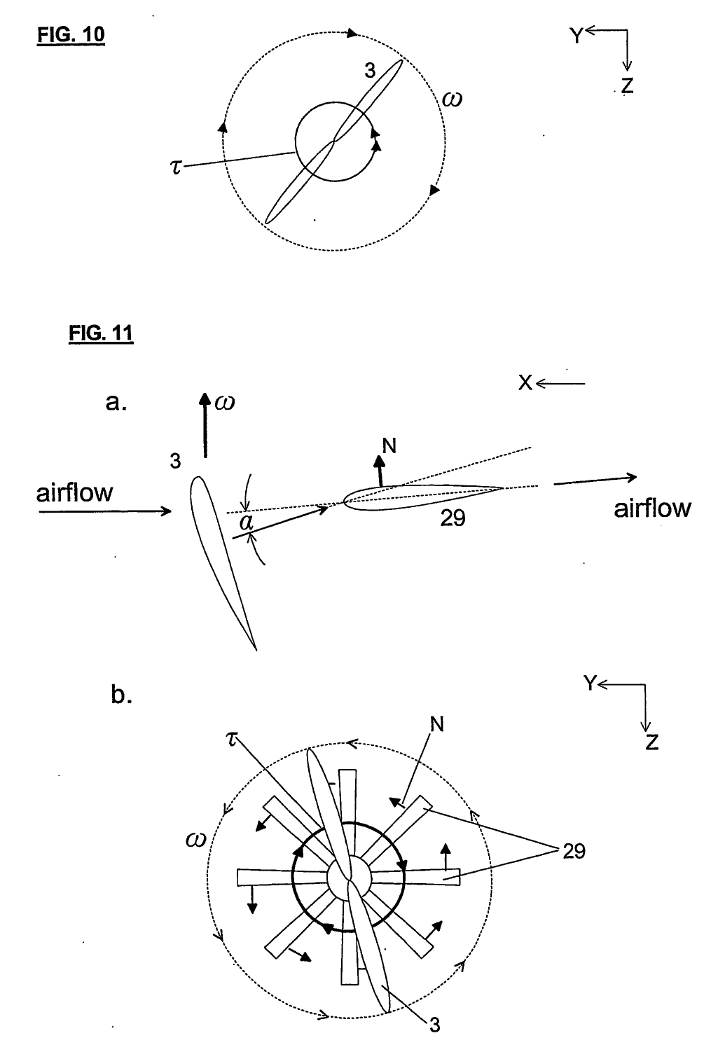

There is also an aerodynamic propeller torque: the aircraft 1 experiences a tendency to roll in a direction opposite to the rotating direction of the single propeller 3 due to propeller drag and the driving engine torque τ. FIG. 10 illustrates this rotation of the propeller 3 and the corresponding engine torque τ. It is proposed in the present invention to generate a counter-torque aerodynamically in order to compensate this aerodynamic propeller torque.

Aerodynamic Torque Compensation is a means of roll control that governs the specific roll caused by the resultant engine torque τ. The features used for roll control can also be used to supplement the aerodynamic torque compensation means.

The resultant engine torque τ is proportional to the thrust T produced by the propeller 3, it is therefore essential to develop an aerodynamic torque compensation that is also related to the thrust T produced, thereby eliminated problems of over-compensation or under-compensation.

Stator

In a preferred embodiment an aircraft 1 according to the invention comprises a stator 29 for aerodynamic torque compensation. The PGA 4 acts on each stator blade, creating small induced forces, shown in FIG. 11. The small induced forces from each stator blade combine to create a counter torque in opposite direction to the torque of the engine τ, shown in the front view of FIG. 11.

The stator 29 is positioned a small distance behind the propeller but far enough so as to keep siren effect to a minimum, this distance is typically one propeller blade chord length.

The stator 29 is a very beneficial means of aerodynamic torque compensation as the counter torque it creates is dependent on the airflow generated by the propeller 3. At higher power, the torque created by the propeller is greater, but the PGA and the angular component of the PGA are both increased. The increased speed and angular component of the PGA will increase the effectiveness of the stator as an aerodynamic torque compensation means since the induced forces created on each blade will be increased. The stator effectiveness will therefore also decrease appropriately with a decrease in power (and thus decrease in engine torque τ). If the engine torque ceased suddenly due to engine failure, the only airflow over the stator blades is the axial ambient airflow, thus the stator blades would have little or no effect.

The stator consists of at least 3 blades, preferably in the order of 12 blades as multiple blades create a more uniform airflow thereby increasing the effectiveness of the PGA 4. The multitude of blades and close position of the stator 29 to the propeller 3 ensures that the stator 29 will not create an adverse lift effect on the main wing 6. The length of the blades would be between 0.4 and 1.5 times the length of the propeller blades.

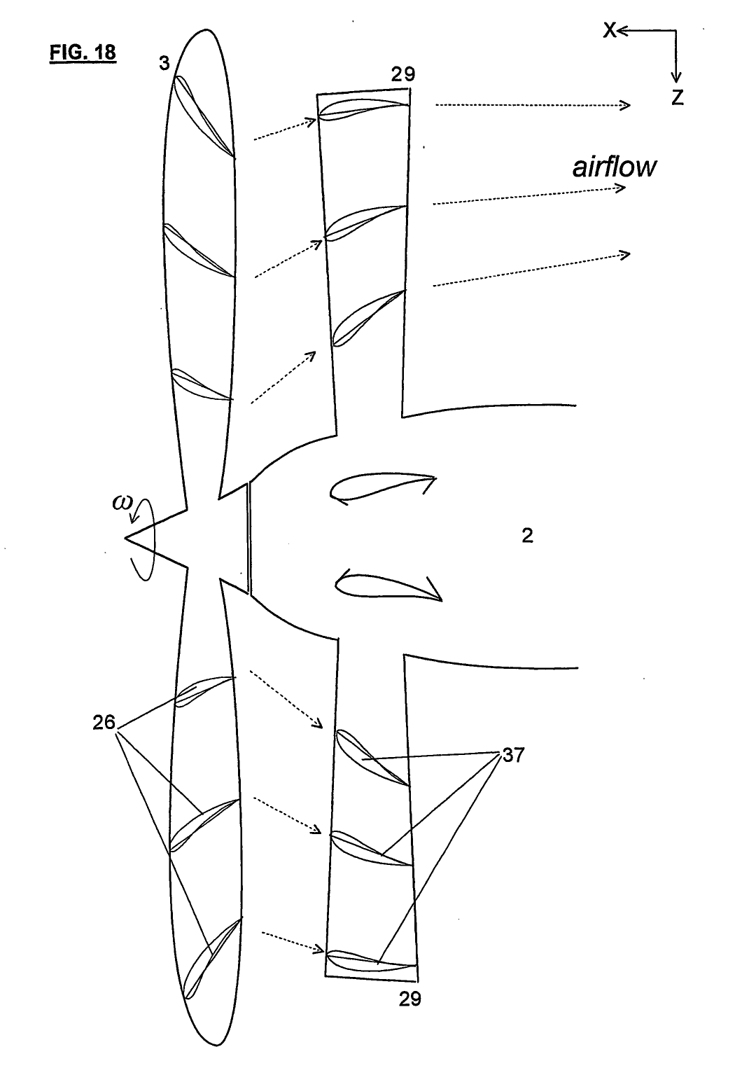

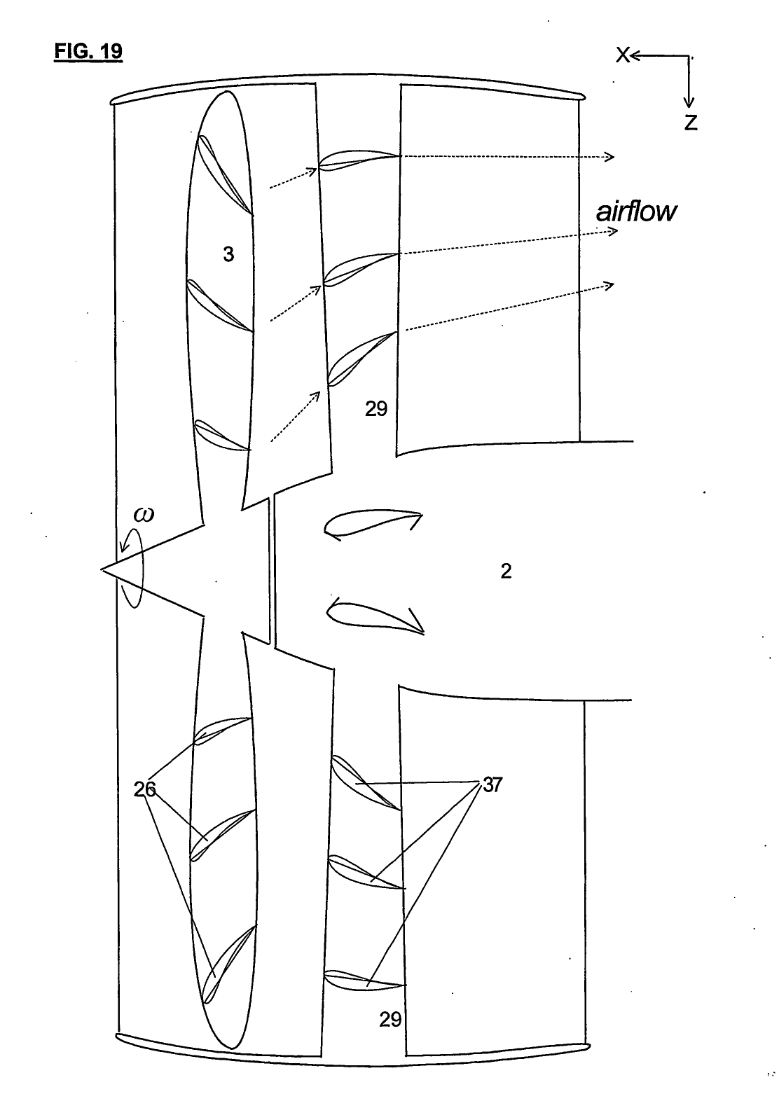

FIGS. 18 and 19 illustrate a possible arrangement of the non-ducted propeller and stator, and of the ducted propeller and stator, respectively, depicting a preferable relative diameter and position of the stator. The twist, of both the propeller and stator blades, is a function of radial position, and is illustrated by the cross-sectional views 26, 37 in FIGS. 18 and 19. The twist of the stator blade is such so as create the required counter torque generated through profile lift (induced forces). The twist is designed such that a fairly constant angle of attack between 6 and 8 degrees is maintained at all radial positions. Large angles of attack and corresponding stall is to be avoided in all conditions. The airflow dictating the angle of attack of the stator blades is a function of the design and operating conditions of the propeller working in front of the stator.

The stator blades may further comprise trailing edge trim flaps, respectively, in order to account for variations in the angular component of the PGA 4. These trim flaps could further be throttle actuated.

Angle of Incidence

In an alternate embodiment, an aircraft 1 according to the invention has different fixed angles of incidence, l_{RW} and l_{LW} of the left and right main wing 6, respectively, shown in FIG. 16. The different angles of incidence l result in different lift capabilities. The wing with the larger angle of incidence l will produce more lift and thus create a roll moment about the x-axis, countering the induced roll due to the engine torque τ.

The required difference in angle of incidence of the main wing 6 is dependent on the speed of the airflow over the wings. During steady horizontal flight, the airflow is faster than during hover flight due to a combination of ambient airflow and PGA 4, thus a smaller difference in the incidence angle l is required. In the alternate embodiment, an aircraft 1 according to the invention has different angles of incidence configured for steady flight in addition to a leading edge device 7 that is further extended on one side of the wings during hover flight to account for the change in airflow by inducing a greater lift on this side. However, the difference in the incidence angle l is present whether the engine is powered or not, thus there could be some undesired roll effects if the power fails during flight.

Size and Profile of Wings

In an alternate embodiment, the counter-torque may be generated by different size of the main wing 6, and/or by different profile effectiveness of the main wing 6 on the left and the right side of the aircraft 1. If the wings 6 have different size or effectiveness in order to compensate for the torque, unwanted roll maneuver will be caused during pitch maneuver. Again, there could be some undesired roll effects if the power fails during flight:

Weighted Wing

In a further embodiment, the counter-torque may be generated by a static weight on right wing for a clockwise rotating engine, or the left wing for a counterclockwise rotating engine. The static weight would create a counter torque that is not variable, and thus would cause undesired roll moments at different power settings, or no power.

Trim Flap

For the preceding further embodiments, the torque compensating means create some amount of undesired roll at different power settings. Therefore, in an further embodiment, a trim flap, is installed on the winglet 28 which could further be mechanically throttle actuated.

6.6 Attitude Control

Aerodynamic torque compensation acts on the roll axis (one of the 3 attitude axes) of the aircraft, thus it is a form of roll control. The features used for roll control can also be used to supplement the aerodynamic torque compensation means.

The aircraft 1 requires a well tuned, but simple control surface for controlling the three degrees of rotational freedom: roll, pitch and yaw, as does any other helicopter or aircraft. If excessive power were applied to a conventional aircraft with its flaps fully extended, it may achieve a small vertical lift off, but it would be unstable in roll, pitch and yaw. The roll control surfaces in conventional aircraft would be useless without significant forward airspeed since they are hardly exposed to any airflow. The rudder and elevators for yaw and pitch control of conventional aircraft are often exposed to some propeller flow, but they are not sized or positioned to handle vertical flight. For this reason, an aircraft 1 according to the invention has similar control surfaces as conventional aircraft, but they positioned primarily within the PGA 4, and are sized for vertical flight.

Roll Control

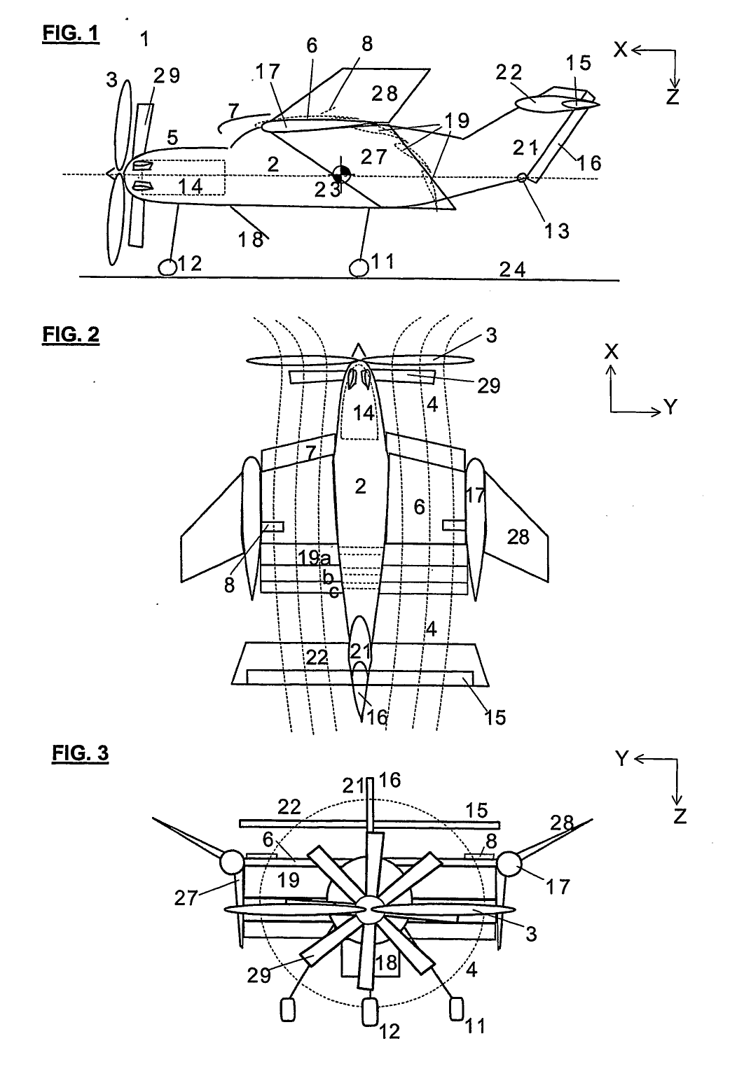

According to a preferred embodiment, the aircraft 1 consists of ventilated spoilers 8 on the main wing 6. The spoilers are positioned on the edge of the PGA 4, where they are effective roll control devices in both vertical and horizontal flight. FIGS. 2 and 3 illustrate the positioning of the spoilers where the pressure gradient above and below the main wing 6 is very high. Ventilated spoilers, illustrated in FIG. 12, are thus very effective in this area, as the ventilation affects the pressure gradient and thereby the lift created by the wing.

Alternatively, the ventilated spoilers could be positioned completely within the PGA 4.

In an alternative embodiment, the main wing 6 could consist of ailerons or non-ventilated spoilers positioned within the PGA 4 for roll control. Ailerons are non-preferred as they could interfere with the Fowler flaps.

In an alternative embodiment, the leading edge devices 7, positioned in the PGA 4, could be used for roll control.

Pitch Control

In a preferred embodiment pitch control of the aircraft 1 according to the invention is achieved through conventional elevator 15 control surfaces being mounted within the PGA 4.

Yaw Control

Directional control of the aircraft is achieved through rudder control surfaces 16 at the tail being mounted in the PGA 4. Alternatively, nose mounted controls, i.e. forward of the center of gravity 23, in the PGA 4 can be used. However, special care must be taken that these surfaces are free to weather vane, otherwise an unfavorable destabilizing effect at forward airspeeds is generated.

6.7 Ground Effect Compensation:

As the aircraft 1 lifts off, and the gap between the main wing flaps and the ground widens causing a slight pressure loss. This pressure loss behind the center of gravity 23 creates a moment about the y-axis, causing the aircraft 1 to pitch nose-up. Pitch moments change rapidly leaving and entering a ground effect. Therefore, in a preferred embodiment, the fuselage spoiler 18 is mounted underneath the fuselage 2 forward of the center of gravity 23 of an aircraft 1 according to the invention. A fuselage spoiler 18 of this type experiences a similar pressure loss during the initial climb phase, but forward of the center of gravity 23. As both elements cause a corresponding pitch ground effect but with opposite levers with respect to center of gravity 23, a climb-out, stable in pitch can be achieved by using the fuselage spoiler 18. Further, the fuselage spoiler 18 serves to enhance the drag and the lift during take-off and landing, illustrated in FIGS. 5 and 6b.

6.8 Transitional Flight:

The method of transition from vertical to horizontal flight, and back, of an aircraft 1 according to the invention is done through the retraction of the high drag devices, such as the Fowler Flaps 19, the leading edge devices 7, and the fuselage spoiler 18. Because the aircraft 1 according to the invention is propelled in all modes of flight by a single universal propeller 3, and because the aircraft 1 is always flying on aerodynamic lift, there is no distinct aerodynamic change during the transitional flight. Major aerodynamic and flight dynamic changes during transitional flight due to transitions from rotor lifted to attached aerodynamic flow and stall phases involved in these processes have often lead to the failure of VTOL aircraft.

6.9 High Speed Horizontal Flight

The power required for vertical take-off implies that the engine of an aircraft 1 according to the invention will be very powerful, and thus enable high horizontal air speeds. The respective power requirement is similar to existing single engine high performance turbo-prop aircraft. In addition, a conventionally wide wing is not necessary and thus the wingspan can be relatively small, which is beneficial for high speed horizontal flight.

6.10 Over-Center Position and Center of Gravity

The two stable positions of an aircraft 1 according to the invention illustrated in FIGS. 8 and 9 are a result of the position of the center of gravity 23 of the aircraft 1. The center of gravity 23 is along a center x-axis of the aircraft 1, in a positive base position (x-direction distance from main landing gear) between the nose gear wheel 12 and the main gear wheel 11, like in a conventional aircraft. It is so close to the main gear wheel 11, that a nose-up pitch of the aircraft 1 results in a stable parking position on the main gear wheel 11 and the tail support 13 as the base position becomes negative.

In a preferred embodiment, the NUTOL position may be achieved by applying a reverse thrust in the horizontal position with the breaks applied to the main landing gear. The center of gravity 23 rotates with the aircraft about the main landing gear 11 until the base position shifts from positive to negative. This process is referred to as over-center.

In a preferred embodiment, the tail support 13 comprises a bumper in order to attenuate shocks 505 when landing the aircraft 1 in a NUTOL position.

In a preferred embodiment, the tail support 13 is of adjustable length in order to take account of the operational variation of the center of gravity 23 of the aircraft 1, or of a non-horizontal ground 24, illustrated by the two different NUTOL positions in FIG. 9.

A tricycle gear is standard technology, but not the NUTOL position of the present application shown in FIG. 9. Actually, it would be an indication of extreme danger to an airplane pilot if a conventionally designed aircraft inadvertently tilted to the NUTOL position before take-off, since it indicates a too far aft loading of the conventional aircraft with resulting instability and uncontrollability in the air.

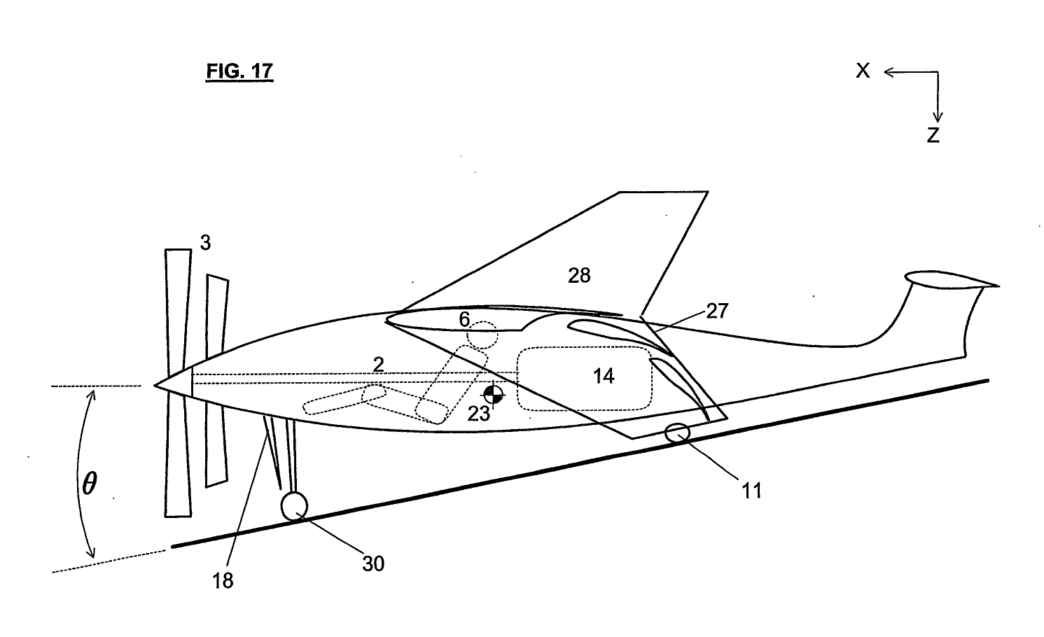

In an alternative embodiment, an aircraft 1 according to the invention only has one stable position, being the NUTOL position. The aircraft 1 according to this alternative is illustrated in FIG. 17. This alternative would not require the over-center means of achieving the NUTOL position, or a tail support 13. The main landing gear 11 is located near the tail, far aft of the center of gravity 23. In order to obtain more stability on the ground, there are 2 nose wheels 30 instead of one. The forward nose wheels 30 are trailing, whereas as the rear main gear 11 are fixed, thus directional stability during take-off and landing is improved. Conventional horizontal take-off and landing is still possible in this alternative embodiment with a slightly retracted configuration of the high lift and drag devices.

6.11 Wing-Tip Configuration

In a preferred embodiment, an aircraft 1 according to the invention comprises a wing-tip 525 configuration (a combination of a end plate 27, winglet 28, and fuel tank 17) that has a multitude of effects:
enhances the moment of inertia about the roll axis,
minimizes the unwanted fuel surge in the y-direction,
creates a stabilizing fuel surge in the x-direction,
alleviates the wing bending moment, decreases internal loads,
complies with aviation certification rules regarding fuel tanks,
reinstates coordinated flight,
acts as a housing for the main undercarriage 11.
   Endplates

According to the preferred embodiment, endplates 27 extend downward from the tips of the main wing 6. The endplates 27 act as a means of containing the PGA 4 and pressure gradient below the main wing 6, thereby enhancing the performance of the flaps. The endplates 27 also act as a guidance for the flap system 19, thereby decreasing the internal loads. The endplates 27 could further be used as a housing for the main undercarriage 11.

Winglets

The presence of the endplates 27 destabilizes the aircraft in roll. The aircraft 1 is therefore provided with winglets 28 which extend outwards and upwards from the tips of the main wing 6 to stabilize the aircraft 1. The winglets 28 act in conjunction with the endplates 27 to reinstate the stable benign roll moment thereby achieving coordinated flight.

The winglets 28 further serve to protect the inner portion of the wing from potential lightning strike.

Fuel Tanks

Any aircraft is subject to instability due to fuel surge in the y-direction. Therefore, in a preferred embodiment, the aircraft 1 is comprised of fuel tanks 17 of cylindrical shape, with the longitudinal axis in the x-direction, thereby minimizing the fuel surge in the y-direction.

The aircraft 1 will have its smallest moment of inertia about the roll axis, and may, to be more conveniently flown by the pilot, require an enhancement of said moment of inertia. Therefore, according to a preferred embodiment of the invention, the fuel tanks 17 are mounted at the intersection of the winglets 28 and the endplates 27, to enhance roll inertia.

In this position, the fuel tanks 17 are protected by the winglets 28 from lightning strike, and thus the aircraft 1 complies with new aviation certification rules.

The x-direction fuel surge in this shape tank 17 is beneficial since when switching from the CHTOL position to the NUTOL position, the contents of the fuel tanks 17 move toward the tail of the aircraft 1, further stabilizing the aircraft 1 in the new position. The same stabilizing effect occur when returning to the CHTOL position.

The tip tanks 17 further serve to alleviate the wing bending moment about the x-axis.

6.12 Longitudinal Weight Trims

In accordance with a preferred embodiment of the invention, the aircraft 1 comprises a trim system for keeping the center of gravity in the longitudinal (x-direction) within narrow limits. Preferably, such trim systems may comprise simple compartments in the nose and the tail that are loaded with shot bags before take-off, in accordance with aircraft loading. Alternatively, the trim system may comprise aft and nose tanks, and means for pumping a liquid to and from said tanks.

The different features mentioned in the description are examples of how the invention may be implemented. The invention is only limited by the appended claims.

### List of Features with Corresponding Reference Signs

| | | | |
|---|---|---|---|
| 1 | aircraft | R | Resultant Force |
| 2 | fuselage | G | Force due to gravity |
| 3 | thrust generating source | T | Thrust |
| 4 | propeller generated | L | Total Lift |
| | airflow (PGA) | | |
| 5 | nose of the aircraft | D | Total Drag |
| 6 | main wing | L_{W} | Lift from Wing |
| 7 | leading edge slat on the | L_{S} | Lift from fuselage spoiler |
| | main wing | | |
| 10 | canard wing | L_{F} | Lift from Flaps |
| 11 | main gear wheel | L_{L} | Lift from leading edge device |
| 12 | nose gear wheel | D_{F} | Drag from Flaps |
| 13 | tail support | D_{S} | Drag from fuselage spoiler |
| 14 | engine | LW | Left Wing |
| 15 | elevator | RW | Right Wing |
| 16 | rudder | L_{LW} | Lift on Left Wing |
| 17 | tip tank | L_{RW} | Lift on Right Wing |
| 18 | fuselage spoiler | ι_{RW} | angle of incidence of right wing |
| 19 | multi-Fowler type of flap | ι_{LW} | angle of incidence of left wing |
| 20 | trim flap on the canard | τ | resultant engine torque |
| | wing | | |
| 21 | vertical stabilizer | α | angle of attack of stator blade |
| 22 | horizontal stabilizer | θ | angle of NUTOL position |
| 23 | center of gravity | ω | propeller rotation |
| 24 | ground | N | induced force on stator blades |
| 25 | protrusion | | |
| 26 | cross section of propeller | | |
| | at radial position | | |
| 27 | endplate | | |
| 28 | winglet | | |
| 29 | stator | | |
| 30 | forward trailing landing | | |
| | gear | | |
| 31 | duct | | |
| 32 | duct nozzle | | |
| 33 | ineffective airflow region | | |
| 34 | hoists for attaching tail | | |
| 35 | carry through area for | | |
| | flap spars | | |
| 36 | effective airflow region | | |
| 37 | cross section of stator at | | |
| | radial position | | |

1. A vertical take-off and landing aircraft (1) comprising a fuselage (2), a main wing (6) and a propeller, the propeller being positioned forward of the wing (6) and in the vertical mid-plane of the fuselage (2), and being adapted to generate an airflow (4) over the wing (6), thereby creating dynamic air at no horizontal speed and enabling vertical flight;
characterized in that the wing (6) is fixed, without any hinge mechanism, to the fuselage with a constant angle of incidence, said wing carrying the aircraft weight during flight;
attitude control means namely for roll, pitch and yaw control, of said aircraft comprising aerodynamic control surfaces positioned within said propeller generated airflow, PGA, (4) and in areas of induced pressure gradients from said propeller generated airflow;
the propeller is a single constant speed propeller (3), either free or ducted, and adapted for propelling the aircraft during all modes of flight, including vertical flight, horizontal flight, and transitional flight between vertical and horizontal flight;
said propeller employs a constant speed control system during vertical and transitional flight regimes in order to avoid inertial propeller torque;
a stator, either ducted or non-ducted, for compensating an aerodynamic torque produced by said propeller, said stator comprising blades fixed to the fuselage, the number thereof being at least 3 blades, while preferably in the order of 6 to 20 blades, said stator being positioned directly downstream of the propeller, at a minimal distance from the propeller where the angular velocity component of the downstream propeller airflow (4) is highest and thus minimal surface area of the stator blades is required to effectively counter the propeller torque, said distance being from one half to three propeller blade chord lengths, a distance large enough to reduce siren effect, each of said stator blades having a radial twist (37) corresponding to the radial twist of the propeller blades (26) such that the downstream propeller airflow remains attached to each of the said stator blades throughout their radial extension, said stator blades having a radial length between 0,4 and 1,5 times the radial length of the propeller blades.

2. Aircraft according to claim 1, wherein said propeller (3) is ducted and comprises a nozzle (32) which redirects the otherwise ineffective airflow (33) in the direction of the aerodynamic surfaces.

3. Aircraft according to claim 1, wherein said propeller is ducted such that the duct rotates with the propeller blades and the blades acts as spokes of the duct.

4. Aircraft according to any one of claims 1-3, whereby the rotor blades of said propeller are positioned such that the angles between the blades are not equal, thereby reducing the noise produced by the propeller while the off-balanced centrifugal forces caused by this arrangement of the blades is re-balanced by means of static weights on the appropriate blades.

5. Aircraft according to any of the preceding claims, further comprising high lift and high drag devices positioned within the propeller generated airflow, said high lift and drag devices being retractable, thus enabling transitional flight between vertical flight and conventional horizontal flight.

6. Aircraft according to claim 5, wherein said high lift and high drag devices are of a trailing edge nature, comprising downwardly deflecting and backwardly extending flaps (19a, 19b, 19c), such as multi-Fowler type or Handley page type flaps.

7. Aircraft according to claim 6, whereby said trailing edge flaps are single full wingspan flap extending through the fuselage.

8. Aircraft according to any one of claims 5 to 7, whereby said high lift and high drag devices further comprise forward extending leading edge devices, such as a slat, a nose flap or a Krueger flap (7); said leading edge device improving lift capabilities but having little effect on drag.

9. Aircraft according to any one of the preceding claim, comprising a fuselage spoiler (18) consisting of a flat plate hinged such that it is flush with the fuselage surface when retracted and produces a high drag due to stalled flow as it is extended, said fuselage spoiler (18) arranged underneath the fuselage (2) between the thrust generating source (3) and the center of gravity (23) such that said fuselage spoiler (18) acts as a means of balancing the pitch attitude of said aircraft (1) in take-off or landing, thereby avoiding pitch attitude offset created by the pressure build-up around the extended flaps aft of the center of gravity in ground effects.

10. Aircraft according to any of the preceding claims, whereby the main wing (6) further comprises a wing-tip configuration consisting of two downwardly extending endplates (27) in combination with two upwardly and outwardly extending winglets (28) positioned at the ends of the main wing; said endplates (27) providing a containment for the PGA (4) and for the pressure below the wing; said winglets stabilizing the aircraft by countering the destabilizing effect of the endplates, re-establishing coordinated flight; said winglets (28) further serving to protect the inner portion of the wing from potential lightning strikes.

11. Aircraft according to claim 10 whereby said endplates (27) further serve as a guidance system for wing trailing edge and leading edge retractable high lift and high drag devices according to claims 6 and 8.

12. Aircraft according to either claim 10 or 11 whereby said endplates (27) further serve as a housing for the main landing gear (11).

13. Aircraft according to any of the preceding claims further comprising fuel tanks of x-wise (longitudinally) elongated geometry, such as cylinder or pipes with minimal dimension in the y-direction, thereby further stabilizing the aircraft by minimizing the lateral (or y-direction) fuel surge.

14. Aircraft according to claims 10 to 13, whereby said fuel tanks (17) are positioned at the intersection of the winglets and the endplates, where they are most effective in alleviating the wing-bending moments during flight and in enhancing the roll inertia.

15. Aircraft according to any of the preceding claims, further comprising a tail support (13) positioned aft of a main gear wheel (11) and underneath the fuselage (2), whereby the aircraft (1) is positioned such that it is stable in a nose-up take-off and landing position, NUTOL, on the main gear wheel (11) and the tail support (13) with the main gear wheel (11) and the tail support (13) being in the same horizontal plane, due to the position of the center of gravity (23) between said main gear wheel and said tail support.

16. Aircraft according to claim 15, whereby said NUTOL position is further stabilized by the x-wise fuel surge in said fuel tanks (17) shifting said center of gravity (23) further aft.

17. Aircraft according to any one of claims 15 and 16, whereby said tail support (13) further comprises a shock absorber in order to attenuate shocks when landing the aircraft.

18. Aircraft according to any one of claims 15 to 17, whereby said tail support (13) is of adjustable length in order to take account to a non-horizontal ground at take-off or landing and of operational variation of the center of gravity (23).

19. Aircraft according to any of the preceding claims, further comprising a nose gear wheel (12) in the nose of the aircraft (1), whereby the aircraft (1) is stable in a conventional horizontal take-off and landing, CHTOL, position on the nose gear (12) and on the main gearwheel (11) being in the same horizontal plane, due to the position of the center of gravity (23) between the main landing gear and the nose gear wheel.

20. Aircraft according to any of the preceding claims, whereby the landing gear comprises two trailing forward wheels and two aft fixed wheels (30), with the center of gravity (23) positioned between the two sets of wheel thereby providing a stable NUTOL position.

21. Aircraft according to claim 8, whereby said torque caused by the propeller is further compensated during vertical flight by said leading edge device having greater extension, thus greater lift, on one wing than the other, i.e. left or right.

22. Aircraft according to any of the preceding claims, whereby said torque caused by the propeller is further compensated by means of the main wing (6) having a different angle of incidence, and/or having different profile effectiveness, and/or being of different sizes on the left and the right side of the aircraft (1).

23. Aircraft according to any one of the preceding claims, comprising a static weight on either the right or left main wing (6) for compensating a torque produced by said propeller (3).

24. Aircraft according to any one of the preceding claims, whereby said stator blades further comprise trailing edge trim flaps respectively to account for changes in the rotational airflow component.

25. Aircraft according to any one of claims 10 to 24, further comprising a trim flap being positioned on said winglet (28) and functioning to compensate the torque caused by the propeller.

26. Aircraft according to either claims 24 and 25, whereby said trim flaps are mechanically actuated by a throttle, thereby providing for the difference in resultant torque at different thrust levels.

27. Aircraft according to any one of the preceding claims, wherein the propeller blades are configured to produce an airflow with a rotational velocity; said rotational velocity inducing greater lift on one wing than the other to counteract the torque caused by said propeller.

28. Aircraft according to any of the preceding claims, wherein spoilers, either ventilated or non-ventilated, are positioned either within said PGA or within the area affected by the pressure gradient created by said PGA, thereby enabling roll control.

29. Aircraft according to any of the preceding claims further comprising rudder and elevator controls mounted on the aircraft empennage whereby said rudder and elevator controls are exposed to the propeller generated airflow (4) and are conditioned with respect to size and position for vertical flight.

30. Method for achieving NUTOL position of the aircraft according to any one of claims 15-29, comprising the following steps:
positioning the aircraft (1) in a horizontal position on the nose gear wheel (12) and on the main gear wheel (11),
applying reverse thrust to the thrust generating source (3) while the main gear wheel is locked in position, thereby tilting the aircraft (1) to a stable nose-up pitched on the main gear wheel (11) and on the tail support (13).

31. Method for vertical take-off of the aircraft according to any one of claims 15 to 29, comprising the following steps:
positioning the aircraft (1) in the NUTOL position on the ground (24)
lifting said aircraft (1) vertically in the NUTOL position by means of increasing the force of propeller (3), thereby increasing the propeller generated airflow (4) and the induced lift on the main wing (6).

32. Method for vertical landing of aircraft according to any of claims 15 to 29, said method comprising the following steps:
increasing the angle of attack of the aircraft to achieve vertical flight,
during vertical flight, reducing the thrust from said thrust generating source (3) thereby reducing the induced lift on the wings, resulting in a vertical descent.
making a vertical touch down in the NUTOL position.

33. Method for transition from vertical flight to horizontal flight of the aircraft according to any one of the preceding claims, the method comprising the steps of: gradual retraction of all high drag devices to gradually reduce drag to a minimum thereby enabling optimal forward horizontal flight; retracting the high lift and drag devices so as to obtain the original wing profile and retracting the fuselage spoiler to its position flush with the fuselage surface.
